(19) United States
(12) Patent Application Publication
(10) Pub. No.: US 2005/0076706 A1
(43) Pub. Date: Apr. 14, 2005

(54) Apparatus and method for use in detecting a seal and paint failure

(75) Inventor: Edward G. Sergoyan, Mill Creek, WA (US)

Correspondence Address: FITCH EVEN TABIN AND FLANNERY, 120 SOUTH LA SALLE STREET, SUITE 1600, CHICAGO, IL, 60603-3406, US

(73) Assignee: The Boeing Company, Chicago, IL (US)

(21) Appl. No.: 10/682,096

(22) Filed: Oct. 8, 2003

(51) Int. Cl. G01M 3/22

(52) U.S. Cl. 73/40.7; 73/46

(57) ABSTRACT

The present invention provides for systems, apparatuses and methods for use in determining if seals leak. The method includes sealing a seal, exposing the seal on a first side to a luminescent, generating a light, directing the light to impinge on a second side of the seal, and determining if the luminescent solution passed the seal to the second side of the seal. An alternative method provides for detecting if a seal on an aircraft is failing, including sealing the aircraft seal, exposing the seal to a luminescent, directing light at a second side of the seal, and determining if light is emitted from luminescent that passed the seal to the second side. An apparatus for detecting a failure of a seal can include a light source generating a light to impinge on the seal, and a detection filter that receives an emitted light and filters the emitted light.

### BACKGROUND OF THE INVENTION

The present invention relates generally to the detection of leaks, and more particularly to the detection of leaks through seals of aircrafts. Airplanes are pressurized at certain altitudes to maintain the comfort level of the passengers and crew, to ensure passengers and crew can breath and other factors. In order to maintain this pressurization, the passenger and crew compartments must be sufficiently air tight that pressurization can be maintained.

Further, some seals on an airplane are directly exposed to the environmental elements, such as a rain, snow, cold and other elements. As such, it is desired that seals exposed to the external environment do not leak to allow water, cold and other elements into the passenger and crew quarters.

To maintain these conditions, some seals on an airplane, such as seals around doors, seals around windows and other such seals need to be secure and not leak or leak only minimally.

Similarly, seals on ships, boats, some manufacturing equipment, some engines, and many other seals are designed not to leak. However, sometimes components forming the seal are improperly manufactured, manufactured with flaws, are installed incorrectly, ware over time and other such factors that result in seals not being tight and leaking.

Also in the manufacturing and assembly of airplanes, it is very expensive and time consuming to paint airplanes. The paint is a critical aspect to an airplane in resisting corrosion. The protection provided by the paint is dependent on how well the paint is applied to the aircraft surface. In some instances, contaminants can get onto an airplane surface prior to painting that can interfere with the ability of the paint to adhere to the airplane surface. As such, paint applied over these contaminants may later peel, bubble and/or warp. These defects in the paint must be corrected to properly maintain the plane and avoid further damage to the structure of the plane.

Repairing of peeling or bubbling paint can be very time consuming and costly, even for small areas. The damaged paint must be stripped, the plane surface properly cleaned and prepared, and then repainted. Some of the costs include the labor costs, the tools utilized in repairs, defueling and refueling the aircraft, the facility in which the repair takes place (paint hangers), the cost of materials (cleaning fluids, primers, paint, and other such materials) as well as other costs.

The present invention advantageously addresses the above and other needs.

### SUMMARY OF THE INVENTION

The present invention advantageously addresses the needs above as well as other needs by providing systems, apparatuses and methods for use in determining if a seal is failing. One embodiment provides a method for use in determining if a seal leaks. The method includes sealing a seal, exposing the seal on a first side to a luminescent solution, generating a light at a first wavelength, directing the light to impinge on at least a portion of a second side of the seal, and determining if the luminescent solution passed the seal to the second side of the seal. The method can, in some embodiments, further include altering an atmospheric pressure on a first side of the seal prior to the exposing of the seal to the luminescent solution, and releasing the pressure on the first side of the seal prior to directing the light along the second side of the seal.

In some embodiments, the present invention provides a method for use in detecting if a seal on an aircraft is failing that include sealing a seal on an aircraft, exposing at least a portion of a first side of the seal to a luminescent, directing a light beam at a second side of the seal, and determining if the luminescent passed the seal to the second side including determining if light is emitted from the luminescent that passed the seal to the second side. Determining if the luminescent passed the seal to the second side can include determining if the luminescent on the second side of the seal emits light at a predefined wavelength.

In a further embodiment, the invention can be characterized as an apparatus for use in detecting a failure of a seal. The apparatus can include a source configured to generate a light beam projected at a first wavelength range to impinge on at least a portion of one side of the seal, and a detection filter positioned to receive an emitted light emitted from about the one side of the seal, wherein the detection filter filters the emitted light emitted from about the seal.

Further, some embodiments advantageously addresses the needs above as well as other needs by providing systems, apparatuses and methods for use in detecting contaminants on surfaces of aircrafts. The method comprises generating a first light at a first predefined wavelength; directing the first light at a surface of an airplane; filtering a first emitted light emitted off of the surface of the airplane; determining if the first emitted light is emitted at a second wavelength; and determining if a first contaminant is present on the airplane surface.

In another embodiment, the invention can be characterized as a method for use in painting a surface. The method comprises determining if a contaminant is present on a surface and painting the surface if the contaminant is not detected. The determination of whether a contaminant is present includes generating a light; filtering the light to generate a first filtered light at a first wavelength range; directing the first filtered light onto the surface; filtering a first emitted light from the surface; and determining if the first emitted light is passed during the filtering of the first emitted light.

In a further embodiment, the invention can be characterized as an apparatus for use in detecting contaminants on a surface of an aircraft, comprising a light source configured to generate a first light beam projected at a first wavelength range, wherein the light source is positioned such that the first light beam impinges on an aircraft surface; and a first detection filter positioned to receive a first emitted light emitted from the aircraft surface, wherein the first detection filter filters the first light emitted from the aircraft surface.

A better understanding of the features and advantages of the present invention will be obtained by reference to the following detailed description of the invention and accompanying drawings, which set forth illustrative embodiments in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a simplified block diagram of a contamination detection system according to one embodiment of the present invention;

FIG. 2 depicts an elevated plane view of an emitted light or detection filter according to one embodiment of the present invention;

FIG. 3 depicts a simplified block diagram of an apparatus for projecting light onto a surface to excite contaminants on the surface;

FIG. 4 depicts a simplified block diagram of an apparatus for use in scanning a surface for contaminants according to one embodiment of the present invention;

FIG. 5 depicts a simplified flow diagram of a process for determining an excitation wavelength for a specific contaminant and the generation of a transmit light at the desired wavelength for detecting the specific contaminant on a surface;

FIG. 6 depicts a simplified block diagram of an system and apparatus for use in determining if a seal is failing and where along the seal the seal is failing;

FIG. 7 depicts a simplified, magnified view of a seal on a structure with a leak trail shown leaking from the seal; and

FIG. 8 depicts a simplified flow diagram of a process 410 for use in testing seals.

Corresponding reference characters indicate corresponding components throughout the several views of the drawings.

### DETAILED DESCRIPTION OF THE PREFERRED EMBODIMENTS

The present invention provides methods and apparatuses for determining if a seal is failing. Some embodiments are particularly advantageous for testing seals on aircrafts. Aircrafts have many seals. For example, seals around windows, seals around doors, and other seals. It is important that when these seals are closed, a secure seal is maintain, and preferably without leaks.

Additionally, some other embodiments further provide non-contact, non-destructive contamination detection apparatuses, systems and/or methods. The present invention can accurately, quickly and easily detect and locate contaminants on a surface. For example, the present invention can be utilized prior to painting of a surface, such as an aircraft, car or other surfaces to detect contaminants that adversely affect paint adhesion to the surface.

Previous systems and methods for cleaning and preparing aircrafts for painting have failed to adequately ensure the surfaces are adequately cleaned. As a result, contaminants are often still present on the surface when paint is applied to the surface. The contaminants, such as soaps, sealants, oils, lubricants, corrosion inhibitors, residual Alkalizes and hydrocarbons, and other contaminants prevent or reduce the adhesion of the paint to the surface resulting in later blistering, bubbling and peeling. These blistered and peeling areas have to be repaired to prevent future damage to the aircraft surface.

For example, a previous method for preparing an aircraft's surface for painting involved removing a temporary protective coating, which is typically a temporary paint layer applied to protect the surface during construction and assembly. In preparing to paint and/or removing the protective layer, the aircraft surface is cleaned and scrubbed with an abrasive. Once rinsed, the surface is tested to determine if the surface is clean. This test is commonly referred to as the “water break test” where water is sprayed on the surface to see if the water will sheet off leaving no droplets. However, the proper surface tension to pass a water break test is 73 dynes/square cm or less, and a minute amount of soap or other alkaline on the surface can mimic the surface tension that is required to pass the water break test by dropping the surface tension to as low as 20 dynes/square cm. If soap or other contaminants are not detected, they can hydrate in rain or later exposure to water adversely affect paint adhesion causing bubbling, blistering and/or peeling of the paint.

In developing the present non-contact, non-destructive contamination detection system and method, it was discovered that some soaps and other contaminates can e excited at atomic levels to absorb photons. The absorption causes a change in energy that naturally emits or becomes fluorescent. The contaminants radiate light and thus can be detected without the addition of other markers or artificial luminance. The present invention utilizes this naturally occurring excitation characteristic in detecting the contaminants.

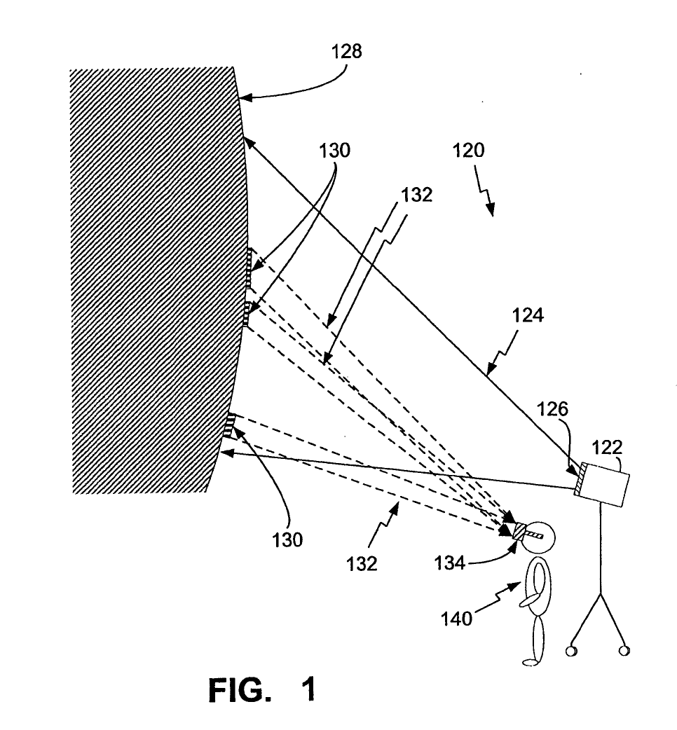

FIG. 1 depicts a simplified block diagram of a contamination detection system 120 according to one embodiment of the present invention. A light source 122 generates a light 124. The light source can be substantially any source capable of illuminating a surface 128 to inspect for potential contaminants 130. For example, the light source can be one or more simple white light flood lamps, one or more hermetically sealed floor lamps, one or more theatrical lamps, one or more lamps for light at a predefined wavelength, one or more lasers and other similar lights or combinations of lights.

In some embodiments, the light source employed is a broadband, large or high powered light source allowing the illumination of a large area. For example, a portable light source can be utilized that can illuminate an area of 10 feet by 10 feet or more. The apparatus can additionally include a fan or other means for cooling of the light source and lenses, filters and other optics utilized in cooperation with the light source. Alternative and/or additionally, the light source can be a laser or other source for generating light at predefined wavelengths.

The light source is typically further configured to operate in hazardous and/or potentially explosive environments. For example, the present invention can be utilized in a paint hanger where potentially explosive paint fumes are often present. As such, the light source 122 is configured to prevent sparking or other conditions that could potentially ignite flammable materials. For example, the light source can be configured with isolated electrical components and/or with a gasket that prevents sparks. Further, the light source is configured such that the operating temperature of the source is sufficiently low as to avoid a potential of ignition.

The apparatus typically employs a light filter 126. The light filter filters the generated light to allow only a limited wavelength range to pass. For example, the filter 126 can filter out the light components out side a wavelength envelope of 485 nm to 495 nm, or 489 nm to 491 nm. As such, only the portion of the light generated from the source having the wavelength of 485 nm to 495 nm (or 489 nm to 491 nm) is passed through the filter 126 as a light beam 124 to impinge on and illuminate the surface 128.

If certain contaminants 130 are present on the surface 128, the filtered light 126 impinges on those contaminants. As discussed above, some contaminants can naturally be excited at an atomic level. When illuminated with a certain wavelength of light the contaminants are excited resulting in a Stokes transition or Stokes shift that causes an emission of light 132 at a second wavelength. Typically, this second wavelength is a longer wavelength than the first wavelength of the light beam 124.

An operator 140 can be positioned proximate the surface 128 and equipped with an emitted light or viewing optical filter 134. The emitted light filter 134 is designed to respond to the light 132 emitted by the excited contaminants 130 to allow the operator 140 to see and detect the emitted light 132 from the contaminants.

This allows the operator 140 to quickly and easily detect contaminants without having to take chemical samples or otherwise contact the surface 128 and without damaging the surface prior to painting. The present detection system 120 additionally allows for the detection of contaminants over a wide area of the surface 128. Because large light sources 122 can be utilized, a large area of light 124 can be projected onto the surface 128 to illuminate a large area of the surface. Further, because a large area can be illuminated the surface can be quickly and easily scanned for contaminants. Therefore, the present detection system can be utilized to quickly scan an entire aircraft by shifting the light 124 along the aircraft to detect contaminants on the aircraft surface.

The operator 140 can move the light source 122 or utilize a lower powered light source, such as a handheld light source, that employs a similar light filter or that emits a similar light 124 at the same first wavelength. This allows the operator 140 to access remote parts of the surface obstructed by other equipment. It allows the operator to move closer to the contaminated area to further analyze the contaminant and/or clean or direct someone to further clean the precise area to eliminate the detected contaminant. In some instances trace amounts of contaminants do not adversely affect the adhesion of the paint. As such, the amount of contaminant detected in these instances should exceed a threshold amount before the surface is further cleaned.

The present detection system 120 is typically also configured to be portable. This allows the apparatus to be moved about the object being scanned, such as an airplane. In some embodiments, the light source is mounted on wheels, is mounted on a track to allow the light to be moved along a fuselage of an airplane, or includes other means for moving the light source. Alternatively, the light source is configured small enough to allow the operator to hold the light source and move the source as needed. Further, the emitted light filter 134 utilized by the operator to detect the contaminants is also configured to be portable. In some embodiments, the emitted light filter is worn by the operator 140.

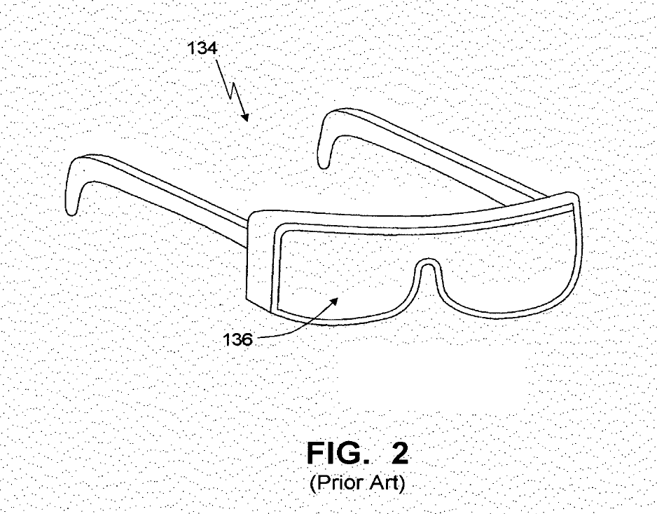

FIG. 2 depicts an elevated plane view of an emitted light or detection filter 134 according to one embodiment of the present invention. The emitted light filter 134 is in the form of goggles or glasses that are worn by the operator. The goggles 134 include lenses 136 that are designed to filter light reflected and emitted from the surface being scanned as well as ambient light. The lenses also act as a pass filter to block light that may interfere with the emitted light from the surface. This allows the emitted light 132 (see FIG. 1) at the second wavelength to pass through the emitted light filter 134 so that the user can more easily see and detect emissions from one or more contaminants.

It is noted that the present detection apparatus 120 is capable of detecting contaminates without adding additional markers, phosphorescent or other artificial luminance. This is particularly advantageous in the aerospace industry. Because aircrafts are subject to strict governmental and industry regulations, excessive amounts of testing and verification must be performed to show that any added markers or phosphorescence do not adversely affect the aircraft, the structure of the aircraft and the construction of the aircraft. This testing and verification can be extremely costly and time consuming.

The present invention avoids the need to use artificial luminance and thus avoids the need to perform testing and verification by utilizing light 124 generated at specific wavelengths to cause the contaminants as they exist without additional markers to be excited. The excited contaminants then emit light 132 that can be detected.

The present detection apparatus, system and method can additionally be configured and implemented to detect a plurality of different contaminants. For example, in preparing an aircraft for painting several contaminants can interfere with the adhesion of the paint to the aircraft's surface. Some of these contaminants include soap, corrosion resistant compounds, oil, lubricants, silicon and other such contaminants. For example, silicon used around sealed windows, doors and other sealed areas can dissolve when exposed to some products such as cleaning solution products (e.g., a methol-ethol-keyton (MEK)) and the solution can potentially leach from the seals. This leaching limits adhesion of the paint to the surface. As such, the present invention can be configured to advantageously detect several different contaminants.

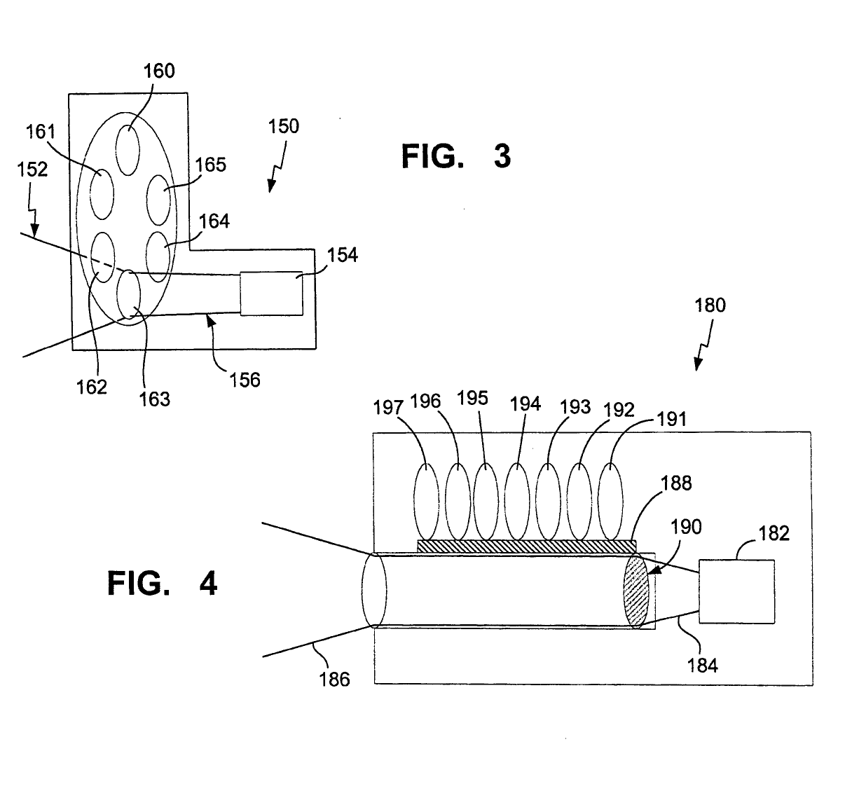

FIG. 3 depicts a simplified block diagram of an apparatus 150 for projecting light 152 onto a surface 128 (not shown) to excite contaminants on the surface. The apparatus 150 provides for the generation and projection of a light beam 152 at a plurality of different wavelengths. The apparatus includes an exciter or light source 154 that generates a white light 156. The apparatus further includes a plurality of filtering optics 160-165. The filtering optics can be implemented through one or more lenses, gradients, and other optics elements. The white light 156 passes through the optics elements (e.g., element 163) to be filtered resulting in a transmitted light beam 152 that has a specific wavelength or wavelength range. For example, the transmitted light 152 can be a light beam having a wavelength with a maximum transmission of 490 nm (blue light).

In one embodiment, the light source 154 generates a high powered light such that the transmitted light 152 can be directed from a large distance away onto a large area of a surface being analyzed. Typically, the light source can be positioned 10 feet, 20 feet or more away from the surface in ambient light to illuminate a large area of the surface. For example, with a 2 million foot candle light source at a distance of about 20 feet from an aircraft, approximately ¼ of the aircraft fuselage can be viewed and inspected for contaminants. This allows accurate and quick inspections of the surface and thus does not interfere with or slow the painting process.

Because the viewing or emitted light filters 134 (see FIGS. 1 and 2) are separate from the light source, more than one operator can be equipped with emitted light filters further speeding the process of inspecting a surface. In some embodiments, the detection apparatus 150 can additionally be implemented as a handheld device for closer examination of surfaces.

In operation, the apparatus 150 allows for the detection of several different contaminants. For example, the plurality of optics elements 160-165 can be sequentially transitioned into alignment with the light source 154 to receive and filter the white light 156 generating the transmitted light 152 at the desired wavelength(s). For example, a first optics element 160 can be shifted into alignment with the source 154 filtering the light 156 such that the transmitted light is transmitted at a first wavelength (e.g., at around 250 nm). The transmitted light 152 excites a first contaminant if present on the surface allowing the operator to detect the first contaminant. Often the apparatus can excite more than one type of contaminant with a single wavelength light. These contaminants then emit light at one or more wavelengths to be detected with one or more emitted light filters 134.

A second optics element 161 can then be transitioned into alignment with the light source 154 while the first optics element 160 is transitioned out of alignment. The second optics element filters the light 156 passing a transmitted light 152 at a second wavelength range (e.g., at around 390 nm). The transmitted light at the second wavelength causes an excitation of a second contaminant if present that in turn emits a second emitted light that can be detected.

A third optics element 162 can then be transitioned in alignment with the light source 154 and the second optics element 161 can be transitioned out of alignment. The third optics element filters the light 156 passing a transmitted light 152 at a third wavelength (e.g., at around 490 nm). The transmitted light at the third wavelength causes an excitation of a third contaminant that emits a third emitted light (e.g., at about 525 nm) that can be detected.

The apparatus 150 can continue to transition or cycle through each of the plurality of optics elements 160-165 and/or combination of optics elements to allow the detection of a plurality of different contaminants. For example, the apparatus 150 can be configured to project a transmit light 152 at a plurality of different wavelengths or wavelength ranges that are between 250 nm to 900 nm depending on the contaminant(s) attempting to be detected. This allows a surface to be quickly scanned for any number of contaminants. The apparatus can be constructed with substantially any number of optics elements for testing of any number of contaminants.

The first, second, third, and so on, emitted lights typically are each at different wavelengths. As such, the emitted light filters 134 (see FIGS. 1 and 2) are also switched when the optics elements 160-165 are switched. This allows the operator to detect each of the emitted lights. In the embodiment where the emitted light filter is implemented through a pair of goggles, the operator switches goggles when the optics elements 160-165 are switched. Other emitted light filters can be utilized that also allow the operator to also switch between optics elements to view the emitted light.

FIG. 4 depicts a simplified block diagram of an apparatus 180 for use in scanning a surface for contaminants according to one embodiment of the present invention. The scanning apparatus 180 includes a light source 182 that generates a light 184. The light impinges on one or more of a plurality of filters 190-197 or other optical elements for conditioning the light 182. A plurality of filters 191-197 can be utilized in combination to achieve the desired transmit light at the desired wavelength or wavelengths. The filters 190-197 filter the light to provide a transmitted light 186 at predefined wavelengths. The filters can be sequentially rotated or transitioned into the light path to sequentially produce a plurality of transmit beams 186 at different wavelengths. In one embodiment, the filters 190-197 are secured with a beam 188. The beam allows each filter to rotate individually into and out of alignment with the light source 182. The transmitted light beams 186 can be directed onto a surface to scan for any number of contaminants on the surface. Other devices can be utilized to achieve the desired wavelength such as adjustable gradients and other devices.

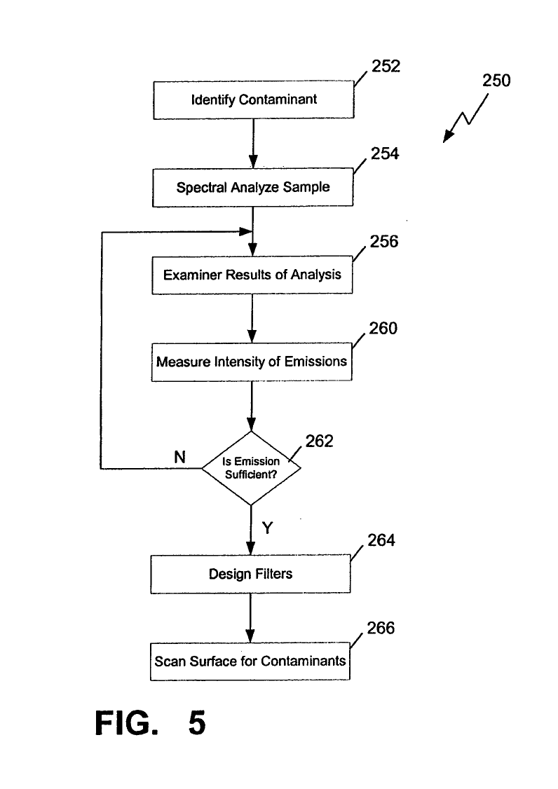

FIG. 5 depicts a simplified flow diagram of a process 250 for determining an excitation wavelength for a specific contaminant and the generation of a transmit light at the desired wavelength for detecting the specific contaminant on a surface. In step 252, the specific contaminant is identified. For example, the contaminant can be a corrosion resistance material or compound applied to the interior of an aircraft, such as Corban 35 or other corrosion inhibitors. In step 254, a sample of the specific contaminant is obtained and a spectral analysis is performed on the contaminant. For example, a florescent spectrophotometer (such as a spectrophotometer from Hitachi, Japan) can be utilized to perform the spectral analysis.

In step 256, the results of the spectral analysis are examined and an approximate ideal excitation wavelength is determined for the specific contaminant. In step 260, a fluorometer is utilized to measure the intensity of light emission when the sample is excited with light at the determined ideal wavelength to determine if the approximate ideal wavelength is accurate and to fine tune the selected excitation wavelength in an attempt to maximize the excitation of the contaminant. In step 262, it is determined if the luminescence of the sample is sufficient and can the selected wavelength and emitting wavelength be isolated with current optical technology, for example, with optical coating(s). If not, the process returns to step 256 in an attempt to determine an alternate wavelength.

In step 264, a filter or filters are designed to filter generated light to achieve the desired transmit beam at the desired wavelength. In one embodiment, a grating device is adjusted or tilted over a variety of positions to achieve the excitation wavelength. Alternatively, a light source can be developed to generate a light at the desired excitation wavelength such as a laser. In step 266, the filter, grating and/or light source is employed to scan a surface to detect the specific contaminant.

In one embodiment, the present invention provides a method and apparatus for detecting leaks in seals. There are many devices and products that employ seals. Often these seals are to be gas (e.g., air) or fluid tight preventing gases or fluids from passing through the seal. However, in many instances it is very difficult to determine if a seal is failing, and where a seal is failing if the seal is in fact failing.

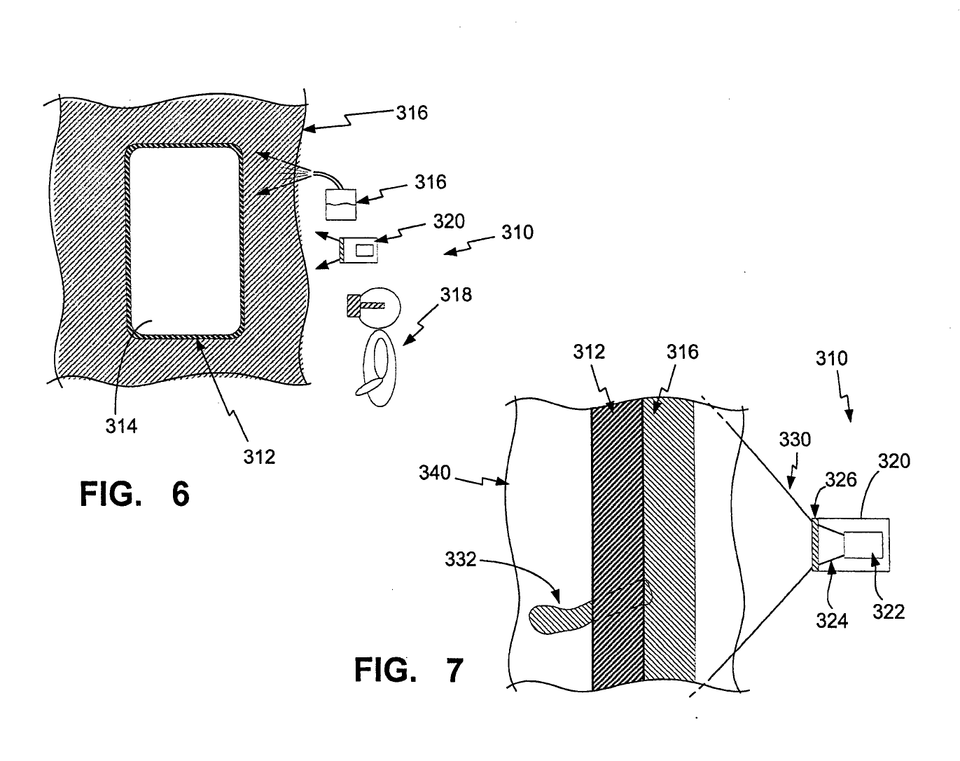

FIG. 6 depicts a simplified block diagram of a system and apparatus 310 for use in determining if a seal 312 is failing and where along the seal the seal is failing. For example, in the aerospace industry, doors, windows and other openings to the exterior of the aircraft must be sealed so that the interior of the aircraft can be pressurized to allow individuals within the aircraft to breathe and operate normally. The present detection system 310 can be utilized to determine if and where a seal is failing.

Initially, seal 312 is closed, for example, a door 314 in an aircraft is closed and secured. The pressure of the interior of the aircraft is increased to simulate high altitude conditions. A luminescent solution 316 that is atomically excitable such as a soap solution, a dye or marker solution (e.g., water and fluorescein) or other solution, is applied to the interior side of the seal 312. For example, a fog of the luminescent solution can be generated with an atomizer near the seal, the solution can be sprayed on the seal, or other similar methods for exposing the solution to the seal can be utilized while the seal is under pressure. The seal is kept closed and under pressure for a period of time.

Following the period of time, the pressure is released on the interior of the aircraft and thus the seal 312. The seal 312 is then opened (e.g., the door 314 is opened) and the seal inspected for leaks. FIG. 7 depicts a simplified, magnified view of a seal 312 on a structure 340 (such as a door jam of an aircraft). A detection light source 320 of the detection system 310 is positioned proximate the seal 312. The light source 320 includes a light generator 322 that generates a light 324 (e.g., a high powered light bulb). The light 324 can be a white light, a light at a specific wavelength, a laser or other similar light. In one embodiment, the light source 320 includes a filter 326 for filtering the light 324 prior to the light being projected onto the seal 312 and surrounding structure 340.

The projected light 330 at the predefined wavelength impinges on the luminescent solution 316 that has been applied to the seal, causing the luminescent solution to excite. The excited solution 316 emits an emission light that can be viewed and/or detected by an operator 318 (see FIG. 6). If a leak in the seal 312 exists, the luminescent solution travels through the leak while under pressure to the exterior side of the seal creating a luminescent solution trail 332 that extends from the seal at the leak. The solution trail 332 is also excited by the light 330. The excited solution trail 332 emits the same emission light allowing the trail to be easily viewed and/or detected. Therefore, a break in the seal or a seal leak is detected and the location of the leak is precisely identified.

The detection of seal failure can be employed on substantially any seal. For example, the seals around windows can be tested, seals around other components of an aircraft, seals around portions of an engine, seals on ships and boats, seals on manufacturing equipment and substantially any seal where a luminescence can be exposed to the seal and a light can be projected onto the seal.

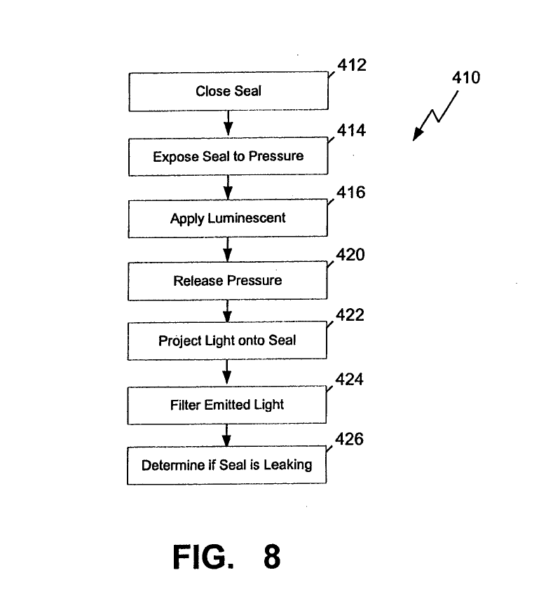

FIG. 8 depicts a simplified flow diagram of a process 410 for use in testing seals according to one embodiment. In step 412, a seal is closed or sealed. In step 414, the seal is exposed to a pressure. In some embodiments, the pressure is applied over the enter seal at once, such as in an aircraft where the pressure in a passenger cabin is altered. In some embodiments, the pressure is a localized pressure on a portion of the seal. It is preferred that the seal or the portion of the seal is exposed to the pressure for at least a predefined period of time.

In step 416, one or more luminescent materials are applied to a side of the seal having a higher pressure. In some embodiments step 416 occurs prior to step 414, such that the luminescent(s) is applied to the seal prior to the seal being put under pressure. In step 420, the pressure is released. In step 422, a light 330 is projected onto the seal, and particularly the side of the seal that was under a lower pressure. In step 424, a light emitted and/or reflected from the seal and surrounding areas is filtered. In step 426, it is determined if the emitted light has a predefined wavelength associated with the luminescent applied to the seal. If the emitted light does not include the wavelength, then the seal is identified as intact and maintaining the intended seal. If the emitted light does include the wavelength, then the seal is considered as failing and a leak is occurring.

The present detection system can also be utilized to locate specific parts or components of a device, machine or product. For example, in the aerospace industry aircrafts are manufactured and assembled with tens of thousands of parts. The detection system is utilized to locate parts within an aircraft, such as identifying critical wiring. The parts of interest (e.g., critical wiring) can be incased or labeled with plastics that can be excited or labeled with fluorescent mark allowing quick and easy identification of specific parts for inspection, maintenance and the like.

While the invention herein disclosed has been described by means of specific embodiments and applications thereof, numerous modifications and variations could be made thereto by those skilled in the art without departing from the scope of the invention set forth in the claims.

1. A method for use in determining if a seal region leaks, comprising:
sealing a seal region;
exposing the seal region on a first side to a luminescent solution;
generating a light and filtering the light with a first filter to produce a first light at a first wavelength;
directing the first light to impinge on at least a portion of a second side of the seal region;
shifting a second filter into alignment with the light and filtering the light with the second filter to produce a second light at a second wavelength;
determining if the luminescent solution passed the seal region to the second side of the seal region.

2. The method of claim 1, further comprising:
altering an atmospheric pressure on a first side of the seal region prior to the exposing of the seal region to the luminescent solution; and
releasing the pressure on the first side of the seal region prior to directing the light along the second side of the seal region.

3. The method as claimed in claim 2, further comprising:
filtering light emitted from about the seal region; and
wherein the determining if the luminescent solution passed the seal region includes determining if the emitted light is emitted at a third wavelength.

4. The method of claim 1, further comprising:
altering an atmospheric pressure on a first side of the seal region after the exposing of the seal region to the luminescent solution.

5. The method of claim 4, wherein the altering the atmospheric pressure includes altering the atmospheric pressure to only a portion of the seal region.

6. The method as claimed in claim 1, wherein the exposing includes atomizing the luminescent solution proximate the seal region.

7. A method for use in detecting if a seal on an aircraft is failing, comprising:
sealing a seal region on an aircraft;
exposing at least a portion of a first side of the seal region to a luminescent;
directing a light beam at a second side of the seal region;
shifting a plurality of filters into alignment with the light beam;
filtering the light beam with the plurality of filters such that the combination of filters creates a first filtered beam;
directing the first filtered beam at the second side of the seal region; and
determining if the luminescent passed the seal region to the second side including determining if light is emitted from the luminescent that passed the seal region to the second side.

8. The method of claim 7, further comprising:
increasing a pressure to at least a portion of the first side of the seal region proximate the at least the portion of the seal region exposed to the luminescent for a predefined period of time.

9. The method of claim 8, wherein the increasing the pressure includes increasing the pressure within at least a passenger cabin of the aircraft.

10. The method of claim 9, further comprising:
releasing the pressure prior to the directing the light beam at the second side; and
opening the seal region to expose the second side of the seal region prior to the directing the light beam at the second side.

11. The method of claim 8, wherein the determining if the luminescent passed the seal region to the second side includes determining if the luminescent on the second side of the seal region emits light at a predefined wavelength.

12. An apparatus for use in detecting a failure of a seal region, comprising:
a source configured to generate a light beam projected to impinge on at least a portion of one side of the seal region;
a plurality of filters fixed proximate the source such that each of the plurality of filters are configured to be shifted into the path of the light beam to filter the light beam; and
a detection filter positioned to receive an emitted light emitted from about the one side of the seal region, wherein the detection filter filters the emitted light emitted from about the seal region.

13. The apparatus as claimed in claim 12, wherein the light source includes a gasket to prevent ignition of fumes in an environment in which the apparatus is operated.

14. The apparatus of claim 12, wherein the plurality of filters are fixed such that they are independently transitioned into alignment with the light beam.

15. The apparatus of claim 14, wherein the plurality of filters are configured to allow more than one of the plurality of filters to simultaneously be in alignment with the light beam.

16. The apparatus of claim 13, further comprising:
a rotational dial housing the plurality of filters, where the rotational dial is configured to rotate to sequentially transition the plurality of filters into alignment with the light beam.

17. The apparatus of claim 1, wherein the shifting the second filter comprises shifting the second filter into alignment with the light and the first filter, and the filtering the light with the second filter comprises filtering the first light at the first wavelength with the second filter and producing the second light at the second wavelength.
